(19) United States
(12) Patent Application Publication
(10) Pub. No.: US 2023/0406218 A1
(43) Pub. Date: Dec. 21, 2023

(54) A MOUNTABLE RACK AND KIT FOR A MOTOR VEHICLE AND A METHOD OF MOUNTING A RACK FOR A MOTOR VEHICLE

(71) Applicant: GUILLAUME BEDARD, North Vancouver (CA)

(72) Inventor: GUILLAUME BEDARD, North Vancouver (CA)

(21) Appl. No.: 18/035,584

(22) PCT Filed: Jul. 20, 2022
(86) PCT No.: PCT/CA2022/051122

§ 371 Date: May 5, 2023

(30) Foreign Application Priority Data
Jul. 26, 2021 (CA) 3126023

(51) Int. Cl. B60R 9/08; B60R 9/06

(52) U.S. Cl. CPC B60R 9/08; B60R 9/06

(57) ABSTRACT

A mountable bicycle, motorcycle or all-terrain vehicle rack for a motor vehicle having a connector mount operable to connect to the motor vehicle, a pivot arm having distal and proximal ends, the proximal end pivotably connected to the connector mount and an actuator connected to the connecter mount and to the pivot arm and operable to actuate the pivot arm between a lowered position and a raised lowered position relative to the connector mount. The actuator may be configured to be electrically connected to an electric source. The rack additionally includes first securing means adjacent the distal end of the pivot arm to secure a first end of the bicycle, motorcycle or all-terrain vehicle to the pivot arm and second securing means adjacent the proximal end of the pivot arm to secure a second end of the bicycle, motorcycle or all-terrain vehicle to the pivot arm.

### CROSS-REFERENCE TO RELATED APPLICATION

This application is a national stage filing under 35 U.S.C. § 371 of international application number PCT/CA2022/051122, filed Jul. 20, 2022, which claims priority to Canadian patent application No. 3126023 filed Jul. 26, 2021. The contents of these applications are incorporated herein by reference in their entirety for all purposes.

### COPYRIGHT NOTICE

This patent document contains material which is subject to copyright protection. The copyright owner has no objection to the facsimile reproduction by anyone of this patent document as it appears in the Patent and Trademark Office patent file or records, but otherwise reserves all copyright rights whatsoever.

### FIELD OF THE INVENTION

The invention relates to the field of racks, and in particular, to mountable bicycle, motorcycle or all-terrain vehicle racks for motor vehicles.

### BACKGROUND OF THE INVENTION

Today, more people are enjoying using their bicycles to commute, for recreation or to perform physical training. In recent years with the improvement in battery technology, electric assisted bicycle (or e-bikes) are becoming more popular. E-bikes provide their users with extended range and make cycling accessible to a wider group of people who may have physical limitations or need to travel faster and further.

Although e-bikes have their advantages, they do come with their own drawbacks. Notably, e-bikes are generally heavier than conventional bicycles and therefore are challenging to load and transport using conventional bicycle racks.

Conventional transport racks come in a variety of choices such as: vehicle roof mounted racks, hitch mounted racks, or trunk mounted racks to name a few. However, conventional racks are not specifically designed to easily accommodate heavier bicycles, motorcycles or all-terrain vehicles and provide no assistance in the loading process.

Accordingly, a need exists for an improved mountable rack that allows a user to easily load and transport heavy vehicles such as bicycles, motorcycles or all-terrain vehicles. Other objects of the invention will be apparent from the description that follows.

### SUMMARY OF THE INVENTION

According to the present invention, there is provided a mountable bicycle, motorcycle or all-terrain vehicle rack for a motor vehicle. The rack may include a connector mount operable to connect to the motor vehicle. A pivot arm having distal and proximal ends may be included with the proximal end pivotably connected to the connector mount. An actuator may be connected to the connecter mount and to the pivot arm and operable to actuate the pivot arm between a lowered position and a raised lowered position relative to the connector mount. The actuator may be configured to be electrically connected to an electric source. A first securing device may be adjacent the distal end of the pivot arm to secure a first end of the bicycle, motorcycle or all-terrain vehicle to the pivot arm and a second securing device may be adjacent the proximal end of the pivot arm to secure a second end of the bicycle, motorcycle or all-terrain vehicle to the pivot arm.

The connector mount may be operable to connect to a trailer receiver of the motor vehicle.

The actuator may be an electric linear actuator, a hydraulic linear actuator, a pneumatic linear actuator, or a piezoelectric actuator.

The electric source may be a battery or the motor vehicle's onboard electrical system.

In the raised position, the connector mount and the pivot arm may form an interior angle of less than 90°.

The first and second securing devices may each comprise straps. Alternatively, the first securing device may include a first cross-member connectable adjacent the distal end of the pivot arm. The first cross-member may include a wheel holder operable to receive a first wheel of the bicycle, motorcycle or all-terrain vehicle and a first wheel securing device to secure the first wheel to the wheel holder. The second securing device may include a second cross-member connectable to the pivot arm and operable to receive a second wheel of the bicycle, motorcycle or all-terrain vehicle and a second wheel securing device to secure the second wheel to the second-cross member. The first and second wheel securing devices may each comprise a strap.

The pivot arm may include opposed first and second sides and when it is in the raised position, the first side may be adjacent the motor vehicle and the bicycle, motorcycle or all-terrain vehicle may be secured to the pivot arm adjacent the second side.

According to a second embodiment of the present invention, there is provided a mountable bicycle, motorcycle or all-terrain vehicle rack for a motor vehicle. The rack may include a connector mount operable to connect to the motor vehicle. A pivot arm having distal and proximal ends may be included with the proximal end pivotably connected to the connector mount. An actuator may be connected to the connecter mount and to the pivot arm and operable to actuate the pivot arm between a lowered position and a raised lowered position relative to the connector mount. The actuator may be configured to be electrically connected to the motor vehicle's onboard electrical system. A first cross-member may be connectable adjacent the distal end of the pivot arm and may include a wheel holder operable to receive a first wheel of the bicycle, motorcycle or all-terrain vehicle. A second cross-member may be connectable adjacent the distal end of the pivot arm and operable to receive a second wheel of the bicycle, motorcycle or all-terrain vehicle. There may be a first wheel securing device to secure the first wheel to the wheel holder and a second wheel securing device to secure the second wheel to the second cross-member.

The connector mount is operable to connect to a trailer receiver of the motor vehicle.

The actuator may be an electric linear actuator, a hydraulic linear actuator, a pneumatic linear actuator, or a piezoelectric actuator.

In the raised position, the connector mount and the pivot arm form an interior angle of less than 90°.

The first and second wheel securing devices may each comprise a strap.

The pivot arm may include opposed first and second sides and when it is in the raised position, the first side may be adjacent the motor vehicle and the bicycle, motorcycle or all-terrain vehicle may be secured to the pivot arm adjacent the second side.

In accordance with yet another embodiment of the present invention, there is provided a method of mounting a bicycle, motorcycle or all-terrain vehicle rack to a motor vehicle which may include providing a connector mount and connecting said mount to the motor vehicle, providing a pivot arm having distal and proximal ends and pivotably connecting the pivot arm to the connector mount at the proximal end wherein the connector mount and the pivot mount are substantially in planar alignment in a lowered position, providing an actuator and electrically connecting the actuator to an electric source and connecting the actuator to the connecter mount and to the pivot arm. The method may further include providing a first securing device and securing a first end of the bicycle, motorcycle or all-terrain vehicle to the pivot arm adjacent the distal end of the pivot arm, operating the actuator to actuate the pivot arm from the lowered position to a raised position, and providing a second securing device and securing a second end of the bicycle, motorcycle or all-terrain vehicle to the pivot arm adjacent the proximal end of the pivot arm.

The method may also include connecting the mount to the motor vehicle's trailer receiver.

The method may also include connecting the actuator to a battery or to the motor vehicle's onboard electrical system.

The method may also include securing the first and second ends of the bicycle, motorcycle or all-terrain vehicle to the pivot arm with individual straps.

The method may also include providing a first cross-member connectable adjacent the distal end of the pivot arm with the first cross-member including a wheel holder operable to receive a first wheel of the bicycle, motorcycle or all-terrain vehicle and a first wheel securing device to secure the first wheel to the wheel holder.

The method may also include providing a second cross-member connectable to the pivot arm and operable to receive a second wheel of the bicycle, motorcycle or all-terrain vehicle and a second wheel securing device to secure a second wheel of the bicycle to the second-cross member.

The method may also include using individual straps as first and second wheel securing devices.

In yet another embodiment of the present invention, there is provided a mountable bicycle, motorcycle or all-terrain vehicle rack kit for a motor vehicle. The kit may include a connector mount operable to connect to the motor vehicle, a pivot arm having distal and proximal ends with the proximal end pivotably connectable to the connector mount, an actuator connectable to the connecter mount and to the pivot arm and operable to actuate the pivot arm between a lowered position and a raised position relative to the connector mount. The actuator may be configured to be electrically connected to an electric source. The kit may also include a first securing device to secure a first end of the bicycle, motorcycle or all-terrain vehicle to the pivot arm and a second securing device to secure a second end of the bicycle, motorcycle or all-terrain vehicle to the pivot arm.

The connector mount may be operable to connect to a trailer receiver of the motor vehicle.

The actuator may be an electric linear actuator, a hydraulic linear actuator, a pneumatic linear actuator, or a piezoelectric actuator. The actuator may be configured to be electrically connected to battery or to the motor vehicle's onboard electrical system.

The connector mount and the pivot arm may be pivotably connectable to form an interior angle of less than 90°.

The first and second securing devices may each be a strap. Alternatively, the first securing device may include a first cross-member connectable adjacent the distal end of the pivot arm and may include a wheel holder operable to receive a first wheel of the bicycle, motorcycle or all-terrain vehicle and a first wheel securing device to secure the first wheel to the wheel holder. The second securing device may be a second cross-member connectable to the pivot arm and operable to receive a second wheel of the bicycle, motorcycle or all-terrain vehicle and a second wheel securing device to secure the second wheel to the second-cross member.

The first and second wheel securing devices may each be a strap.

Other aspects of the invention will be appreciated by reference to the detailed description of the preferred embodiment and to the claims that follow.

### BRIEF DESCRIPTION OF THE DRAWINGS

The preferred embodiment of the invention will be described by reference to the drawings thereof in which:

FIG. 1 is an isometric view of a mountable rack in a raised position in accordance with an embodiment of the invention;

FIG. 2 is a side view of the rack of FIG. 1 attached to a motor vehicle;

FIG. 3 is an isometric view of an actuator of the rack of FIG. 1;

FIG. 4 is a perspective view of the rack of FIG. 1 attached to the motor vehicle;

FIG. 5 is an isometric view of the rack of FIG. 1 attached to the motor vehicle in a lowered position;

FIG. 6 is a perspective view of the rack of FIG. 1 attached to the motor vehicle in a raised position;

FIG. 7 is a perspective view of the rack of FIG. 1 attached to the motor vehicle in a lowered position with a front wheel attached thereto;

FIG. 8 is a perspective view of the rack of FIG. 1 attached to the motor vehicle in a semi-raised position with a front wheel attached thereto;

FIG. 9 is a perspective view of the rack of FIG. 1 attached to the motor vehicle in a raised position with a front wheel attached thereto;

FIG. 10 is a perspective view of a securing device of the rack of FIG. 1; and

FIG. 11 is an isometric view of a mountable rack in accordance with another embodiment of the invention.

### DESCRIPTION OF THE PREFERRED EMBODIMENT OF THE INVENTION

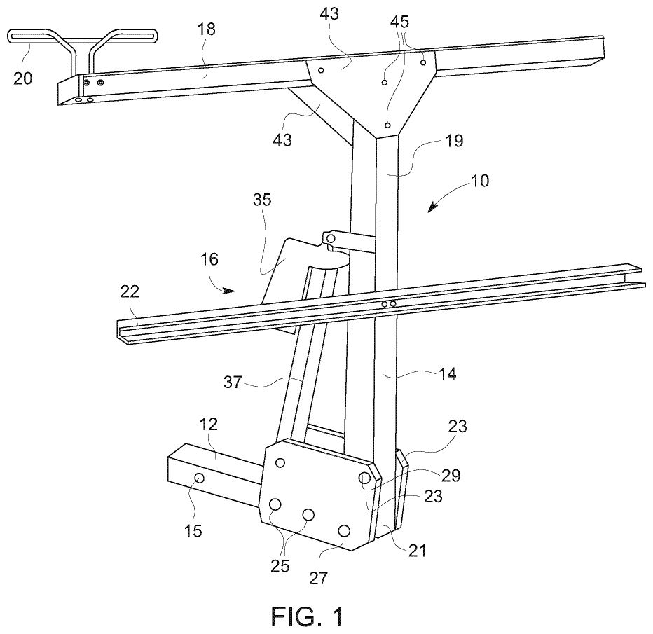

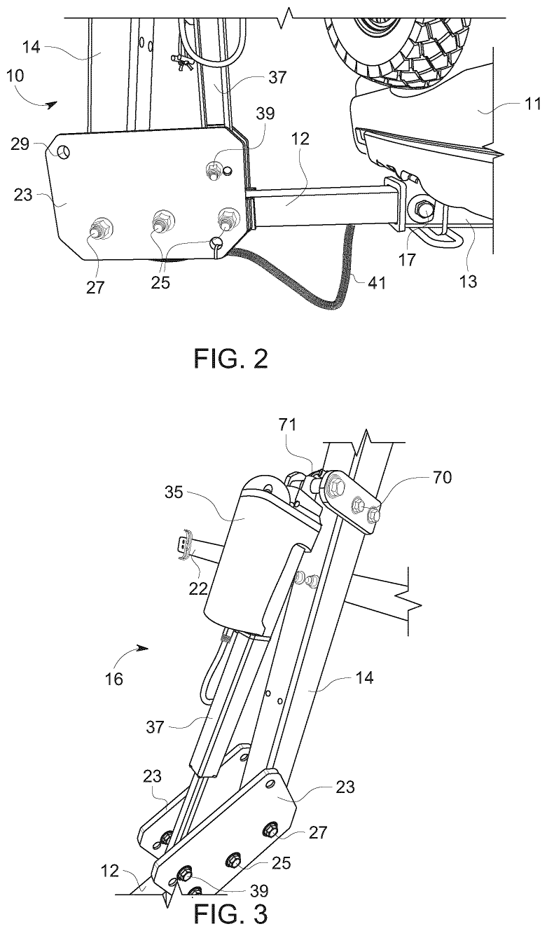

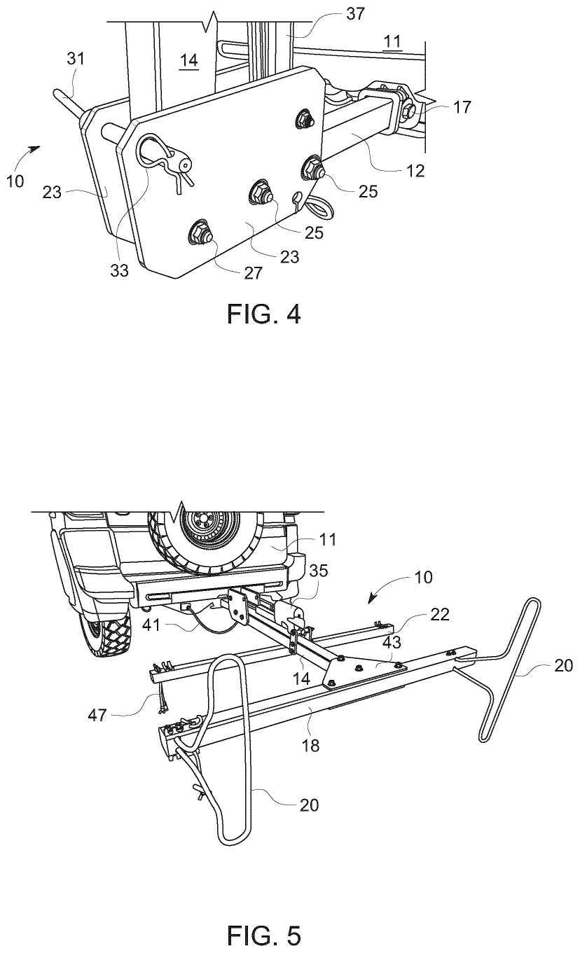

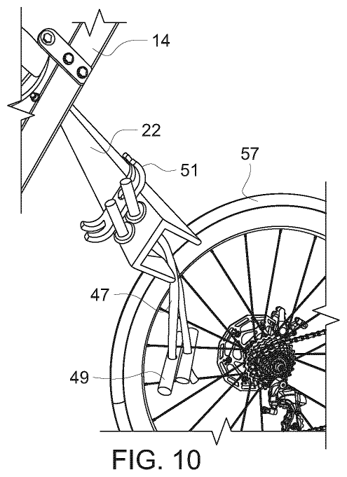

Referring to FIGS. 1 to 11 there is provided a mountable bicycle rack 10 for a vehicle 11. Although rack 10 depicts a rack for use with a bicycle, those skilled in the art will appreciate that the rack may be suitably configured for use with a motorcycle, all-terrain vehicles and the like.

Referring to FIGS. 1, 2 and 4 there is provided a mountable bicycle rack 10 for a motor vehicle 11. The rack 10 includes a connector mount 12 operable to connect to the motor vehicle 11, preferably via a trailer receiver 13. Connector mount 12 is a conventional draw bar of any suitable dimension, for example 2″×2″, 1.5″×1.5″ or 1″, 1″ for example. To secure the rack 10 to the motor vehicle 11, male connector mount 12 is conventionally inserted into female trailer receiver 13. Hole 15 on connector mount 12 is lined up with a corresponding hole (not shown) on the trailer receiver 13 and pin 17 is inserted therethrough to secure the connector mount to the receiver. Preferably, hole 15 is threaded to accept a ⅝ threaded pin 17. Pin 17 will preferably have at its free end a hole (not depicted) configured to receive a locking device to prevent removal of the pin from the connector mount 12 and thus locking the rack 10 to the motor vehicle 11.

The rack 10 also includes a pivot arm 14 having distal 19 and proximal ends 21. The proximal end 21 is pivotably connected to the connector mount 12. To provide the pivot connection, in the preferred embodiment, twin plates 23 are secured to the connector mount 12 via fasteners 25 and the proximal end 19 is secured to the twin plates via a pivot connector 27 which allows the pivot arm 14 to freely pivot about the connector mount. Fasteners 25 and pivot connector 27 may simply have the same nut and bolt configuration. Twin plates 23 may each have a through-hole 29 so that a conventional pin 31 can be inserted therethrough to lock the pivot arm 14 in a raised position. To secure the pin 31 within the twin plates 23, a conventional clamp 33 is preferably attached thereto.

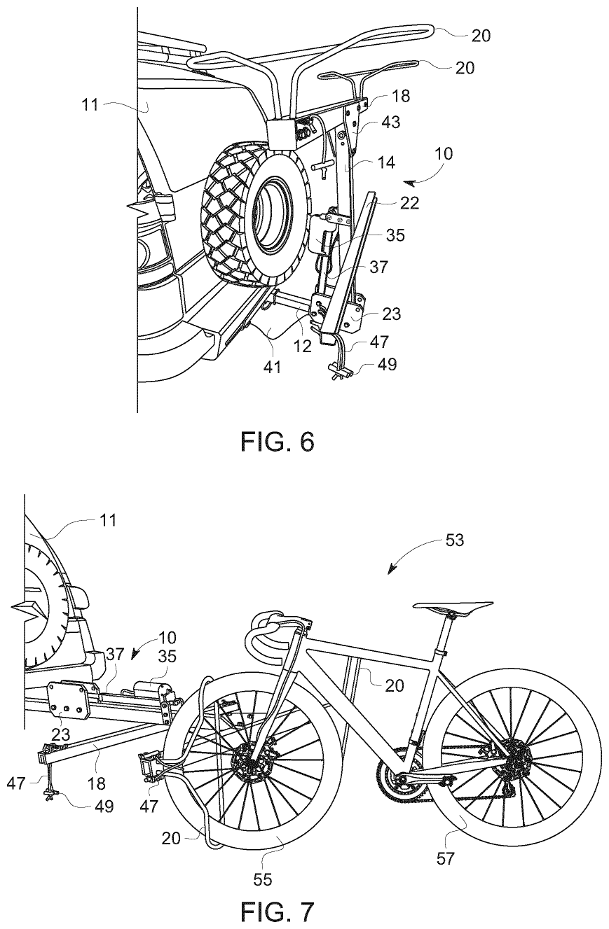

The rack 10 also includes an actuator 16 connected to the connecter mount 12 and to the pivot arm 14 which is operable to actuate the pivot arm 14 between a lowered position (as illustrated in FIG. 5) and a raised position (as illustrated in FIG. 6). The actuator 16 may be a hydraulic linear actuator, a pneumatic linear actuator, a piezoelectric actuator, or preferably, an electric linear actuator. Referring now to FIG. 3, actuator 16 includes an actuator body 35 which is pivotably connected to pivot arm 14 via twin actuator plates 70 connected thereto and actuator pin 71 connected therethrough. Extending from the actuator body 35 is a piston member 37 which extends and retracts therefrom and is connected at its free end to connector mount 12 via fasteners 39 and the twin plates 23. To power the actuator 16, the actuator is configured to be electrically connected to the motor vehicle's 11 onboard electrical system via a conventional wiring harness 41 or alternatively to an external battery.

Referring back to FIG. 1, the rack 10 includes a first cross-member 18 connectable adjacent the distal end 19 of the pivot arm 14. First cross-member 18 is preferably connected to pivot arm 14 via twin mount plates 43. Here, first cross member 18 is mounted perpendicular to pivot arm 14 and fasteners 45 are used to secure the first cross member, pivot arm and twin mount plates together. The first cross-member 18 includes at least one wheel holder 20 operable to receive a first wheel 55 of a bicycle. As those skilled in the art will appreciate, a plurality of wheel holders 20 may be added along first cross-member 18 to accommodate more bicycles on the rack 10, but for the sake of illustration, only one wheel holder has been depicted. The wheel holder 20 is shaped to easily accommodate and frictionally fit any sized bicycle wheel. A second cross-member 22 is connectable perpendicularly and adjacent the distal end 21 of the pivot arm 14 and operable to receive a second 57 wheel of bicycle. Preferably, the second cross-member 22 is adjustably connectable lengthwise along pivot arm 14 to allow for various bicycle wheelbase lengths. To secure the first and second wheels to the first 18 and second 22 cross-members, rack 10 includes first and second wheel securing devices. Referring now to FIG. 9, the securing devices preferably include straps 47 connected to the cross member 22 which can be wrapped through the wheel 57 and then affixed back onto the cross-member. Straps 47 may include a handle 49 to aid in pulling the straps through the wheel 57 which may then be secured to cross-member 22 via handle catchers 51. Although FIG. 9 depicts the securing device as used on second cross-member 22, it will be appreciated that the same securing device may be used on first cross-member 18. As those skilled in the art will appreciate, any conventional securing devices may be used to secure the first 55 and second wheels of the bicycle to the rack 10.

Operation

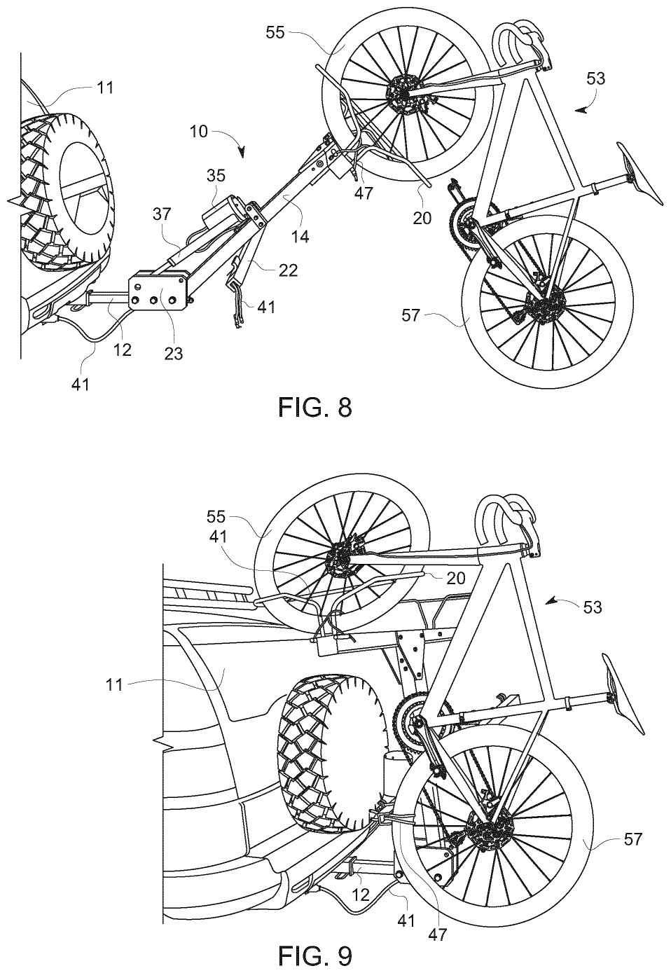

Referring to FIG. 7, after attaching the connector mount 12 to receiver 13, pivot arm 14 is lowered to receive a bicycle 53. First wheel 55 is maneuvered into holder 20 to frictionally engage the wheel and a user may then further secure the wheel within the holder by threading straps 47 through the spokes of the wheel and over the wheelrim and attaching the handle 49 to catcher 51. Referring to FIG. 8, once the first wheel 55 is secured, a user may then operate the actuator 16 (either via remote control or a control unit on rack 10) to raise the pivot arm 14 to a semi raised position. As the arm 14 is raised, bicycle 53 pivots bringing the second wheel 57 closer to the rack 10, and in particular, closer to second cross-member 22. In the semi-raised position, the weight of the bicycle 53 is mainly supported by the rack 10. Here, the user can then lift the second wheel 57 to the second cross member 22 and attach the second wheel to the second cross-member using straps 47, handle 51 in the same manner that was used to attach the first wheel 55 to the holder 20 of first cross-member 18. Referring to FIG. 9, now that the bicycle 53 is fully secured to the rack, a user may further operate actuator 16 to fully raise the pivot arm 14 to its raised position. A user may then use pin 31 and clamp 33 to better secure the pivot arm 14 to the mount 12 while distributing the rotational forces created by the pivot arm and bicycle 53 off of the actuator 16. Preferably, in the fully raised position, the connector mount 12 and the pivot arm 14 form an interior angle of less than 90° thus placing the combined center of gravity of the rack 10 and the bicycle 53 closer to the motor vehicle 11. This is advantageous as other conventional bicycle racks have their center of gravities placed further away from the motor vehicle 11 which adversely affects the driving characteristics of the motor vehicle.

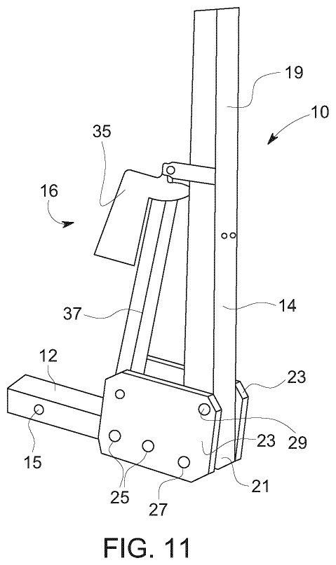

Referring now to FIG. 11 (illustrator to add), there is provided another embodiment of the invention for a single bicycle. Like the preferred embodiment, there is provided a mountable bicycle rack 10 for a motor vehicle 11. The rack 10 includes a connector mount 12 operable to connect to the motor vehicle 11, preferably via a trailer receiver 13 of the motor vehicle 11. Connector mount 12 is a conventional draw bar of any suitable dimension, for example 2″×2″, 1.5″×1.5″ or 1″, 1″ for example. To secure the rack 10 to the motor vehicle 11, male connector mount 12 is conventionally insertable into female trailer receiver 13. Hole 15 on connector mount 12 is lined up with a corresponding hole (not shown) on the trailer receiver 13 and pin 17 is inserted therethrough to secure the connector mount to the receiver. Preferably, hole 15 is threaded to accept a ⅝ threaded pin 17. Pin 17 will preferably have at its free end a hole (not depicted) configured to receive a locking device to prevent removal of the pin from the connector mount 12 and thus locking the rack 10 to the motor vehicle 11.

The rack 10 also includes a pivot arm 14 having distal 19 and proximal ends 21. The proximal end 21 is pivotably connected to the connector mount 12. To provide the pivot connection, in the preferred embodiment, twin plates 23 are secured to the connector mount 12 via fasteners 25 and the proximal end 19 is secured to the twin plates via a pivot connector 27 which allows the pivot arm 14 to freely pivot about the connector mount. Fasteners 25 and pivot connector 27 may simply have the same nut and bolt configuration. Twin plates 23 may each have a through-hole 29 so that a conventional pin 31 can be inserted therethrough to lock the pivot arm 14 in a raised position. To secure the pin 31 within the twin plates 23, a conventional clamp 33 is preferably attached thereto.

The rack 10 also includes an actuator 16 connected to the connecter mount 12 and to the pivot arm 14 which is operable to actuate the pivot arm 14 between a lowered position and a raised position. The actuator 16 may be a hydraulic linear actuator, a pneumatic linear actuator, a piezoelectric actuator, or preferably, an electric linear actuator. Referring now to FIG. 3, actuator 16 includes an actuator body 35 which is pivotably connected to pivot arm 14 via twin actuator plates 70 connected thereto and actuator pin 71 connected therethrough. Extending from the actuator body 35 is a piston member 37 which extends and retracts therefrom and is connected at its free end to connector mount 12 via fasteners 39 and the twin plates 23. To power the actuator 16, the actuator is configured to be electrically connected to the motor vehicle's 11 onboard electrical system via a conventional wiring harness 41.

To secure the bicycle 53 to the pivot arm 14, a first securing device is provided at the distal end 19 of the pivot arm 14 to secure a first end of the bicycle 53 and a second securing device is provided adjacent the proximal end 21 of the pivot arm to secure a second end of the bicycle 53. Here, the first and second securing devices may be any conventional devices, such as straps, and any part of the bicycle 53 may be secured to the pivot arm 14, such as the handlebars, wheels, seat or frame.

Operation of this embodiment follows the same basic steps of the preferred embodiment.

Although preferably offered as a complete unit, bicycle rack 10 may be sold as a kit of components including:
a connector mount 12 operable to connect to the motor vehicle 11; a pivot arm 14 having distal 19 and proximal ends 21, with the proximal end pivotably connectable to the connector mount 12; an actuator 16 connectable to the connecter mount 12 and to the pivot arm 14 and operable to actuate the pivot arm between a lowered position and a raised position relative to the connector mount with the actuator configured to be electrically connected to an electric source; a first securing device to secure a first end of the bicycle 53 to the pivot arm 14; a second securing device to secure a second end of the bicycle 53 to the pivot arm 14; a wiring harness 41 to connect the actuator 16 to an electrical source such as a battery or the motor vehicle's 11 onboard electrical system; and fasteners

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

1. A mountable bicycle, motorcycle or all-terrain vehicle rack for a motor vehicle, the rack comprising:
a connector mount operable to connect to the motor vehicle;
a pivot arm having distal and proximal ends, said proximal end pivotably connected to said connector mount;
an actuator connected to said connecter mount and to said pivot arm and operable to actuate said pivot arm between a lowered position and a raised position relative to said connector mount, said actuator configured to be electrically connected to an electric source;
first securing means adjacent said distal end of said pivot arm to secure a first end of the bicycle, motorcycle or all-terrain vehicle to said pivot arm; and
second securing means adjacent said proximal end of said pivot arm to secure a second end of the bicycle, motorcycle or all-terrain vehicle to said pivot arm.

2. The mountable rack of claim 1 wherein said connector mount is operable to connect to a trailer receiver of the motor vehicle.

3. The mountable rack of claim 1 wherein said actuator is an electric linear actuator, a hydraulic linear actuator, a pneumatic linear actuator, or a piezoelectric actuator.

4. The mountable rack of claim 1 wherein said electric source is a battery or the motor vehicle's onboard electrical system.

5. The mountable rack of claim 1 wherein in said raised position, said connector mount and said pivot arm form an interior angle of less than 90°.

6. The mountable rack of claim 1 wherein said first and second securing means comprise straps.

7. The mountable rack of claim 1 wherein said first securing means comprises a first cross-member connectable adjacent said distal end of said pivot arm, said first cross-member comprising:
a wheel holder operable to receive a first wheel of the bicycle, motorcycle or all-terrain vehicle; and
first wheel securing means to secure said first wheel to said wheel holder.

8. The mountable rack of claim 1 wherein said second securing means comprises:
a second cross-member connectable to said pivot arm and operable to receive a second wheel of the bicycle, motorcycle or all-terrain vehicle; and
second wheel securing means to secure a second wheel of the bicycle, motorcycle or all-terrain vehicle to said second-cross member.

9. The mountable rack of claim 7 wherein said first wheel securing means comprises a strap.

10. The mountable rack of claim 8 wherein said second wheel securing means comprises a strap.

11. The mountable rack of claim 1 wherein said pivot arm comprises opposed first and second sides, wherein when said pivot arm is in said raised position, said first side is adjacent the motor vehicle and the bicycle, motorcycle or all-terrain vehicle is secured to said pivot arm adjacent said second side.

12. A mountable bicycle, motorcycle or all-terrain vehicle rack for a motor vehicle, the rack comprising:
a connector mount operable to connect to the motor vehicle;
a pivot arm having distal and proximal ends, said proximal end pivotably connected to said connector mount;
an actuator connected to said connecter mount and to said pivot arm and operable to actuate said pivot arm between a lowered position and a raised position relative to said connector mount, said actuator configured to be electrically connected to the motor vehicle's onboard electrical system;
a first cross-member connectable adjacent said distal end of said pivot arm, said first cross-member comprising a wheel holder operable to receive a first wheel of the bicycle, motorcycle or all-terrain vehicle;
a second cross-member connectable adjacent said distal end of said pivot arm and operable to receive a second wheel of the bicycle, motorcycle or all-terrain vehicle;
first wheel securing means to secure said first wheel of the bicycle, motorcycle or all-terrain vehicle to said wheel holder; and
second wheel securing means to secure said second wheel of the bicycle, motorcycle or all-terrain vehicle to said second cross member.

13. The mountable rack of claim 12 wherein said connector mount is operable to connect to a trailer receiver of the motor vehicle.

14. The mountable rack of claim 12 wherein said actuator is an electric linear actuator, a hydraulic linear actuator, a pneumatic linear actuator, or a piezoelectric actuator.

15. The mountable rack of claim 12 wherein in said raised position, said connector mount and said pivot arm form an interior angle of less than 90°.

16. The mountable rack of claim 12 wherein said first and second wheel securing means comprise straps.

17. The mountable rack of claim 12 wherein said pivot arm comprises opposed first and second sides, wherein when said pivot arm is in said raised position, said first side is adjacent the motor vehicle and the bicycle, motorcycle or all-terrain vehicle is secured to said pivot arm adjacent said second side.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
